(19) United States
(12) Patent Application Publication
(10) Pub. No.: US 2024/0109246 A1
(43) Pub. Date: Apr. 4, 2024

(54) PLASTICALLY DEFORMABLE 3D OBJECTS WITH HEAT CHANNELS

(71) Applicants: Hewlett-Packard Development Company, L.P., Spring, TX (US); Nanyang Technological University, Singapore (SG)

(72) Inventors: Juha SONG, Singapore (SG); Kiesar Sideeq BHAT, Singapore (SG); Qian SHI, Singapore (SG); Muhammad Aidil BIN JUHARI, Singapore (SG); Aravind Kumar JAYASANKAR, Singapore (SG); Rui Yuan HAN, Singapore (SG); Rafael BALLAGAS, Palo Alto, CA (US); Michael John REGAN, Singapore (SG)

(21) Appl. No.: 18/273,238

(22) PCT Filed: Feb. 19, 2021
(86) PCT No.: PCT/US2021/018783

§ 371 Date: Jul. 19, 2023

(51) Int. Cl. B29C 64/153; B29C 64/188; B29C 64/20; B29C 64/393; B33Y 10/00; B33Y 30/00; B33Y 50/02

(52) U.S. Cl. CPC B29C 64/153; B29C 64/188; B29C 64/20; B29C 64/393; B33Y 10/00; B33Y 30/00; B33Y 50/02; B29K 2105/251

(57) ABSTRACT

In one example in accordance with the present disclosure, an additive manufacturing system is described. The additive manufacturing system includes a build material deposition device to form a plastically deformable three-dimensional (3D) object by depositing layers of a thermoplastic build material to form a body of the plastically deformable 3D object. The additive manufacturing system also includes a heat channel forming device to form heat channels within the plastically deformable 3D object which heat channels, responsive to an applied stimulus, are to soften adjacent regions of the body. The additive manufacturing system also includes a fusing system to selectively harden layers of thermoplastic build material to form the plastically deformable 3D object.

### BACKGROUND

Additive manufacturing systems produce three-dimensional (3D) objects by building up layers of material. Some additive manufacturing systems are referred to as “3D printing devices” and use inkjet or other printing technology to apply some of the manufacturing materials. 3D printing devices and other additive manufacturing devices make it possible to convert a computer-aided design (CAD) model or other digital representation of an object directly into the physical object.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an additive manufacturing system for forming plastically deformable 3D objects with heat channels, according to an example of the principles described herein.

FIG. 2 is an isometric view of an additive manufacturing system for forming plastically deformable 3D objects with heat channels, according to an example of the principles described herein.

FIGS. 3A and 3B depict a plastically deformable 3D object with heat channels, according to an example of the principles described herein.

FIG. 4 depicts a plastically deformable 3D object with heat channels in a face mask, according to an example of the principles described herein.

FIG. 5 depicts a plastically deformable 3D object with heat channels, according to an example of the principles described herein.

FIG. 6 is a flow chart of a method for forming plastically deformable 3D objects with heat channels, according to an example of the principles described herein.

FIG. 7 is a block diagram of an additive manufacturing system for forming plastically deformable 3D objects with heat channels, according to an example of the principles described herein.

FIG. 8 is a flow chart of a method for forming plastically deformable 3D objects with heat channels, according to an example of the principles described herein.

FIG. 9 depicts a plastically deformable 3D object with heat channels in bridges, according to an example of the principles described herein.

FIGS. 10A and 10B depict the deformation of a plastically deformable 3D object with heat channels, according to an example of the principles described herein.

FIG. 11 depicts a plastically deformable 3D object with heat channels, according to an example of the principles described herein.

FIG. 12 depicts a non-transitory machine-readable storage medium for forming plastically deformable 3D objects with heat channels, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Additive manufacturing systems form a three-dimensional (3D) object through the solidification of layers of build material. Additive manufacturing systems make objects based on data in a 3D model of the object generated, for example, with a computer-aided drafting (CAD) computer program product. The model data is processed into slices, each slice defining portions of a layer of build material that are to be solidified.

In one example, to form the 3D object, a build material, which may be powder, is deposited on a bed. A fusing agent is then dispensed onto portions of a layer of build material that are to be fused to form a layer of the 3D object. The system that carries out this type of additive manufacturing may be referred to as a powder and fusing agent-based system. The fusing agent disposed in the desired pattern increases the energy absorption of the layer of build material on which the agent is disposed. The build material is then exposed to energy such as electromagnetic radiation. The electromagnetic radiation may include infrared light, ultraviolet light, laser light, or other suitable electromagnetic radiation. Due to the increased heat absorption properties imparted by the fusing agent, those portions of the build material that have the fusing agent disposed thereon heat to a temperature greater than the fusing temperature for the build material.

Accordingly, as energy is applied to a surface of the build material, the build material that has received the fusing agent, and therefore has increased energy absorption characteristics, fuses while that portion of the build material that has not received the fusing agent remains in powder form. Those portions of the build material that receive the agent and thus have increased heat absorption properties may be referred to as fused portions. By comparison, the applied heat is not so great so as to increase the heat of the portions of the build material that are free of the agent to this fusing temperature. Those portions of the build material that do not receive the agent and thus do not have increased heat absorption properties may be referred to as unfused portions.

Accordingly, a predetermined amount of heat is applied to an entire bed of build material, the portions of the build material that receive the fusing agent, due to the increased heat absorption properties imparted by the fusing agent, fuse and form the object while the unfused portions of the build material are unaffected, i.e., not fused, in the presence of such application of thermal energy. This process is repeated in a layer-wise fashion to generate a 3D object. The unfused portions of material can then be separated from the fused portions, and the unfused portions recycled for subsequent 3D formation operations.

Another way of 3D formation selectively applies binder to areas of loose build material. In this example, a “latent” part is prepared inside a build bed filled with build material. The build bed may be transferred to a furnace where a first heating operation removes solvents present in the applied binder. As solvents are removed, the remaining binder hardens and glues together build material to convert the “latent” part into a “green” part. The green part is then removed from the bed. As a result of this operation, residual build material may be caked onto the green parts. It may be desirable to remove residual build material from green parts in a cleaning operation. In some examples, the green parts are loaded into a sintering furnace where applied heat can cause binder decomposition and causes the build material powder particles to sinter or fuse together into a durable solid form.

In yet another example, a laser, or other power source is selectively aimed at a powder build material, or a layer of a powder build material, to form a slice of a 3D printed part. Such a process may be referred to as selective laser sintering. In yet another example, the additive manufacturing process may use selective laser melting where portions of the powder material, which may be metallic, are selectively melted together to form a slice of a 3D printed part. As yet another example, in fused deposition modeling melted build material is selectively deposited in a layer where it cools. As it cools it fuses together and adheres to a previous layer. This process is repeated to construct a 3D printed part.

In yet another example, the additive manufacturing process may involve using a light source to cure a liquid resin into a hard substance. Such an operation may be referred to as stereolithography. While such additive manufacturing operations have greatly expanded manufacturing and development possibilities, further development may make 3D printing a part of even more industries. Accordingly, a device which carries out any of these additive manufacturing processes may be referred to as an additive manufacturing device and in some cases a printer.

While such additive manufacturing operations have greatly expanded manufacturing and product development, further advances may make 3D printing a part of even more industries. For example, there has been an increase in demand for customized and adaptive material products, particularly for direct use on the human body. For example, wearable technology is an emerging technology and demand has increased for personalized electronic products with better mobility and user experience.

The additive manufacturing processes of the present specification provide for cost-effective and customized production of various objects that are flexible and can easily conform to different surface topologies including the contours of a human face.

While certain flexible materials may allow for such geometric conformance, some wearable applications may be better suited if formed of rigid plastics. For example, orthopedic casts, helmets, and a face mask frame may be better formed out of a rigid material so as to provide protection against mechanical forces and to maintain their shape. Were such devices formed out of a flexible material, they may be ineffective for their intended purpose.

Some devices may implement specialized “smart” materials such as shape memory polymers, liquid crystal elastomers, and composite hydrogels. However, such “smart” materials have manufacturing limitations, may be cumbersome to work with, and are expensive.

Accordingly, the present specification leverages the thermal, electrical, and mechanical behavior of thermoplastic materials such as polyamide and acrylonitrile butadiene styrene (ABS). Specifically, the present system integrates heat channels into a 3D object formed from a thermoplastic material. The heat channels deliver a stimulus to the thermoplastic material which makes the 3D object plastically deformable.

Moreover, devices formed of a “smart” material may not provide localized control of deformation, but rather facilitate an object-wide deformation. By comparison, the systems and methods of the present specification generate 3D objects that generate heat internally and allow local structural deformation. This localized deformation allows the 3D objects to conform to complex geometries, such as the challenging curvatures of the human anatomy.

As such, the present specification describes a method of producing a shape memory object via 3D printing. During 3D printing, a conductor is inserted into select locations of the 3D object, for example, by delivering a conductive agent to the select locations. In an example, the conductor includes 40% polyamide, 40% silver, and 20% fusing agent. After 3D printing, electricity is applied to the conductors which softens the thermoplastic material such that a user may bend the object at the conductor regions. In a particular example, electricity may be applied to restore the 3D object to its original form. Such devices may be applicable to a wide variety of fields including, wearable devices, customized clothing and shoes, and medical instruments.

Specifically, the present specification describes an additive manufacturing system. The additive manufacturing system includes a build material deposition device to form a plastically deformable three-dimensional (3D) object by depositing layers of a thermoplastic build material to form a body of the plastically deformable 3D object. The additive manufacturing system also includes a heat channel forming device to form heat channels within the plastically deformable 3D object. Responsive to an applied stimulus, the heat channels soften adjacent regions of the body of the 3D object. The additive manufacturing system also includes a fusing system to selectively harden layers of thermoplastic build material to form the plastically deformable 3D object.

The present specification also describes a method. According to the method, slices of a plastically deformable 3D object are formed by sequentially depositing a powder thermoplastic build material to form a body of the plastically deformable 3D object. Heat channels are formed in the body. The heat channels are to deliver an applied stimulus to adjacent regions of the body to soften the adjacent regions such that the adjacent regions plastically deform. Electrical leads are coupled to the heat channels to deliver the applied stimulus.

The present specification also describes a non-transitory machine-readable storage medium encoded with instructions executable by a processor. The machine-readable storage medium includes instructions to 1) determine deformable regions of a plastically deformable 3D object to be formed and 2) determine a conductive agent loading to generate heat channels within the deformable regions. The instructions are also executable by the processor to 1) generate instructions to form the heat channels in the deformable region and 2) transmit the instructions to an additive manufacturing system. The instructions direct the additive manufacturing system to form the plastically deformable 3D object and form the heat channels in the body of the plastically deformable 3D object.

Such systems and methods 1) provide re-shapeable devices; 2) facilitates control of the shape of the object to conform to a surface by stimulus such as heat or electricity; 3) facilitate shape-recovery of the 3D object from a deformed state to its original state; and 4) provide localized shape configuration. However, it is contemplated that the systems and methods disclosed herein may address other matters and deficiencies in a number of technical areas.

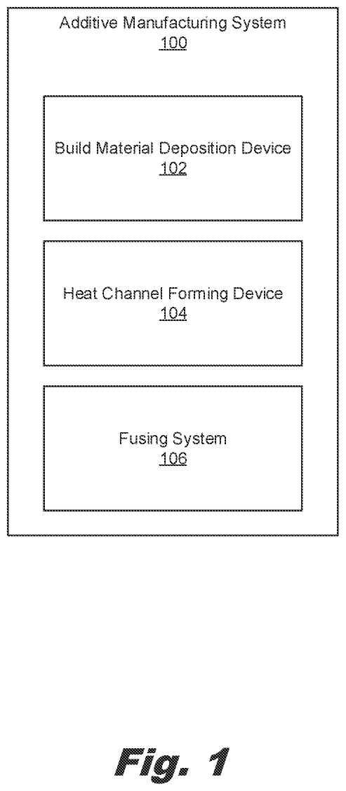

Turning now to the figures, FIG. 1 is a block diagram of an additive manufacturing system (100) for forming plastically deformable 3D objects with heat channels, according to an example of the principles described herein. That is, the 3D objects that are formed and that include the below described heat channels, may be deformable into a particular shape responsive to an applied stimulus. Following removal of the stimulus, the 3D object maintains this deformed shape. That is, the 3D object may be plastically deformable, i.e., retain its deformed shape in the absence of force.

As described above, a 3D printed object may be formed using any variety of additive manufacturing techniques including a fusing-agent based system, a system where a “green” part is passed to a sintering device to sinter particles together. The additive manufacturing device (102) may also be non-agent-based systems such as a selective laser sintering device, a selective laser melting device, a fused deposition modelling device, and a stereolithographic device. In general, apparatuses for generating three-dimensional objects may be referred to as additive manufacturing systems (100).

The additive manufacturing system (100) includes a build material deposition device (102) to form a plastically deformable 3D object. Specifically, the build material deposition device (102) may sequentially deposit layers of a thermoplastic build material to form a body of the plastically deformable 3D object. As the build material is a thermoplastic, it may soften in the presence of an applied stimulus such as heat or electricity. As a specific example, the build material may have a glass transition temperature of between 40 and 80 degrees Celsius. This temperature represents the temperature at which a rigid material becomes plastically deformable. Using a material with a glass transition temperature in this range is safe for use against human skin as it is not so hot as to cause a burn to a user. In a particular example, the build material is polyamide 12 which has a glass transition temperature of between 50 and 60 degrees Celsius.

Without an applied stimulus, the thermoplastic (such as polyamide 12) is rigid and strong. However, when heated past its glass transition temperature it becomes flexible and soft and can therefore be easily deformed under small external force. Once the applied stimulus is removed, the object maintains its deformed shape, which is distinct from an object that is elastically deformable. For instance, an elastically deformable plastic sheet may bend, but after the bending force is removed, the plastic sheet may return to its original shape. However, 3D objects of the present specification, by using a thermoplastic material, remain in a deformed shape once a stimulus is removed.

The additive manufacturing system (100) also includes a heat channel forming device (104) to form heat channels within the plastically deformable 3D object. It is these heat channels which provide the deformability of the 3D object. Specifically, responsive to an applied stimulus, the heat channels soften adjacent regions of the 3D object by, for example, raising the temperature in these adjacent regions to above a glass transition temperature.

In an example, the heat channel forming device (104) may include a component which retrieves a heat channel element, such as a metallic rod, and places it in a layer of soft build material or in a recess formed in a hardened layer of build material. In either example, additional layers of build material may be deposited on top of the metallic rod to complete formation of the 3D object.

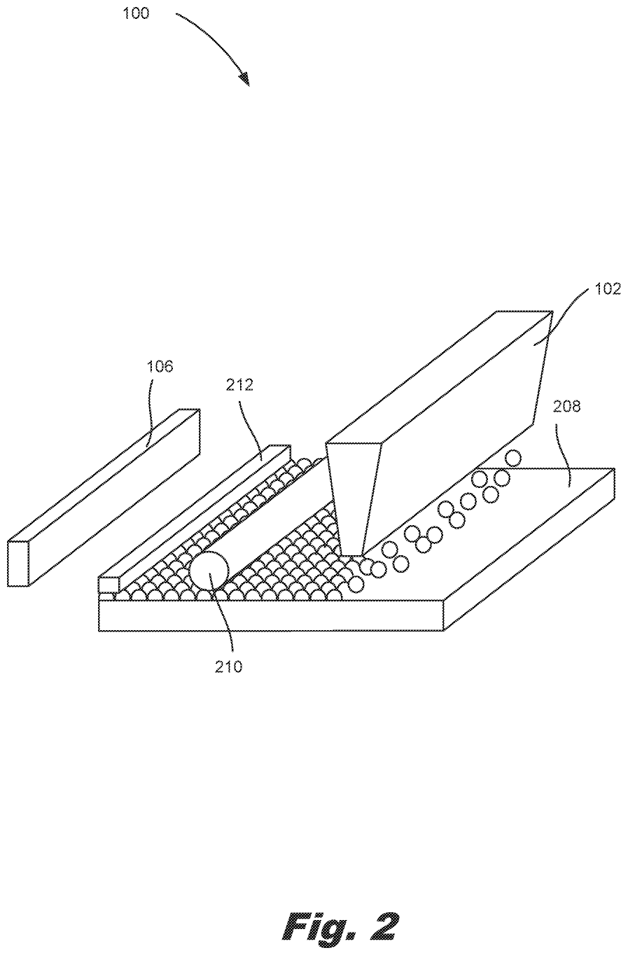

In another example, the heat channel forming device (104) is an agent distribution system to deposit a liquid agent on those regions of the 3D layer that are to form a heat channel. A fusing system (106) of the additive manufacturing device may then fuse the build material with fusing agent thereon to form the 3D object body and fuse the portions of the layer with a conductive agent deposited thereon to form the heat channels. FIG. 2 depicts such an example of an agent-based heat channel forming device (104).

The additive manufacturing system (100) also includes a fusing system (106) to selective harden layers of thermoplastic build material to form the plastically deformable 3D object. In some examples as described above, a fusing or binding agent may be deposited. In this example, the fusing system (106) exposes the agents to energy. When such agents are exposed to energy, they may fuse together the underlying build material. In general, a fusing system (106) may be any component that applies thermal energy. Examples of fusing systems (106) include infrared lamps, visible halogen lamps, resistive heaters, light emitting diodes LEDs, and lasers. While specific examples of a fusing system (106) are provided, other types of fusing systems (106) may be used. For example, a specific example is provided of a fusing system (106) that cures a fusing or binding agent. In other examples, the fusing system (106) may operate on 3D objects that are formed without a fusing or binding agent. For example, in an SLS additive manufacturing system (100) a laser or plurality of vertical-cavity surface-emitting lasers (VCSELs) may be used without a fusing or binding agent. In an example, the fusing system (106) may generate electromagnetic radiation. The electromagnetic radiation may include infrared light, ultraviolet light, laser light, or other suitable electromagnetic radiation.

In an example, the fusing system (106) may be separate from the build material deposition device (102). For example, the fusing system (106) may be a sintering oven.

As described, the additive manufacturing system (100) forms heat channels directly inside the 3D object body to induce local heat generation, and thereby enable local deformation of the 3D object. That is, by applying controlled heat and external force, the polyamide structure of the plastically deformable 3D object is flexible and deformable to a stable secondary shape. By applying heat again, the 3D object is recovered to its original shape.

As described above, the 3D objects of the present specification may be heated, within a few minutes to a temperature above the glass transition temperature of the thermoplastic build material. The composition and geometry of the embedded heat channels may be customized to ensure target heating parameters, all while retaining small current to ensure safe use.

Moreover, the additive manufacturing system (100) allows for the use of more readily available materials, as opposed to “smart” materials such as shape memory polymers, liquid crystal elastomers and composite hydrogels, which may be expensive, complex, and cumbersome to work with and may have physical properties not conducive to use near a human.

Still further, the heat channels facilitate targeted deformation, rather than subjecting the entire object to an applied stimulus (i.e., placing in an oven or hot water) thus resulting in generalized deformation. Accordingly, targeted regions are exposed to the stimulus, thus providing greater customization and fine-tuning of the deformation, while also preserving the lifetime and mechanical performance of the rest of the 3D object.

The additive manufacturing system (100) also reduces the time taken to induce the plastic deformation. That is, in a relatively small amount of time, for example 3 minutes, a change may be induced in the properties of these targeted areas. In some examples, the heat channels are in a patterned structure where a gradient thickness exists, thus inducing various local heating profiles within a heat channel. Through this selective and controllable heat channel formation process, a wide variety of heating profiles and deformation profiles may be achieved.

FIG. 2 is an isometric view of an additive manufacturing system (100) for forming plastically deformable 3D objects with heat channels, according to an example of the principles described herein. Components of the additive manufacturing system (100) depicted in FIG. 2 may not be drawn to scale and thus, the additive manufacturing system (100) may have a different size and/or configuration other than as shown therein.

In general, apparatuses for generating 3D objects may be referred to as additive manufacturing systems (100). The additive manufacturing system (100) described herein may correspond to three-dimensional printing systems, which may also be referred to as three-dimensional printers. An additive manufacturing system (100) may use a variety of operations. For example, the additive manufacturing system (100) may be a fusing agent-based system (as depicted in FIG. 2) or a binding-agent based system. While FIG. 2 depicts a specific example of an agent-based system (100), the additive manufacturing system (100) may be any of the above-mentioned systems (100) or another type of additive manufacturing system (100).

In an example of an additive manufacturing process, a layer of build material may be deposited onto a build area. As used in the present specification and in the appended claims, the term “build area” refers to an area of space wherein the 3D object is formed. The build area may refer to a space bounded by a bed (208). The build area may be defined as a three-dimensional space in which the additive manufacturing system (100) can fabricate, produce, or otherwise generate a 3D object with its embedded 3D heat channels. That is, the build area may occupy a three-dimensional space on top of the bed (208) surface. In one example, the width and length of the build area can be the width and the length of the bed (208) and the height of the build area can be the extent to which the bed (208) can be moved in the z direction. Although not shown, an actuator, such as a piston, can control the vertical position of the bed (208).

The bed (208) may accommodate any number of layers of build material. For example, the bed (208) may accommodate up to 4,000 layers or more. In an example, a number of build material supply receptacles may be positioned alongside the bed (208). Such build material supply receptacles source the build material that is placed on the bed (208) in a layer-wise fashion.

In the additive manufacturing process, a fusing agent may be deposited on the layer of build material that facilitates the hardening of the powder build material. In this specific example, the fusing agent may be selectively distributed on the layer of build material in a pattern of a layer of a 3D object. An energy source (106) may temporarily apply energy to the layer of build material. The energy can be absorbed selectively into patterned areas formed by the fusing agent, while blank areas that have no fusing agent absorb less applied energy. This leads to selected zones of a layer of build material selectively fusing together. This process is then repeated, for multiple layers, until a complete physical object has been formed.

Additional layers may be formed and the operations described above may be performed for each layer to thereby generate a 3D object. The layer-by-layer formation of a 3D object may be referred to as a layer-wise additive manufacturing process.

FIG. 2 clearly depicts the build material distribution device (102). That is, a build material distribution device (102) may deposit thermoplastic powder build material onto the bed (208). The build material distribution device (212) may acquire thermoplastic powder build material from build material supply receptacles, and deposit such acquired material as a layer in the bed (208), which layer may be deposited on top of other layers of build material already processed that reside in the bed (208). In some examples, the build material distribution device (102) may be coupled to a scanning carriage. In operation, the build material distribution device (212) places build material in the bed (208) as the scanning carriage moves over the bed (208) along the scanning axis.

In some examples, a roller (210) or other mechanism may smooth the deposited powder build material. While FIG. 2 depicts a roller (210), other examples of a mechanism to smooth the deposited metal powder build material may include a blade or ultrasonic blade.

FIG. 2 also depicts an agent distribution system (212) to form the plastically deformable 3D object and the heat channels. The agent distribution system (212) may distribute a variety of agents. Specifically, the agent distribution system (212) may include multiple agent distribution devices, each to apply a distinct agent. One specific example of an agent is a fusing agent, which increases the energy absorption of portions of the build material that receive the fusing agent to selectively solidify portions of a layer of powdered build material. The agent distribution system (212) may deposit other agents to form the plastically deformable 3D object. For example, the agent distribution system (212) may deposit a binder agent that temporarily glues portions of the 3D object together.

The agent distribution system (212) may deposit the agents used to form the heat channels as well. For example, the agent distribution system (212) may deposit a conductive agent. The conductive agent may include a metallic nanoparticle ink that includes metal nanoparticles in a carrier fluid. Upon application of an energy during additive manufacturing, the carrier fluid evaporates and the metal nanoparticles fuse together to form a solid metal conductive heat channel. The conductive agent may include a variety of components. For example, the conductive agent may include a combination of a metallic ink and a fusing agent. Examples of metallic inks include silver ink, copper ink, and gold ink among others. In an example, the fusing agent may be a carbon-based agent which may be dark in color and therefore absorbs additional thermal energy from the fusing system (FIG. 1, 106). Note that in this example, the metallic ink and the fusing agent may be distributed separately. That is, one agent distribution device may deposit a metallic ink while another agent distribution device distributes the fusing agent.

The resistance of the conductive heat channel defines the heating capacity within the adjacent regions of the plastically deformable 3D object. Specifically, under the same applied voltage and time, the temperature increase of composites is enhanced with increased resistance. The resistance of the heat channel, and thereby the amount of heat energy to raise the adjacent thermoplastic build material past its glass transition temperature, may be tuned based on the composition of the conductive agent. For example, for a heat channel where the fraction of silver is larger than that of the build material, the silver forms the matrix and build material is dispersed within the silver matrix, indicating that the conductivity is more heavily influenced by the silver. Thus, the conductivity in this region tends to be more like that of silver. By comparison, when the amount of silver and build material is equal, the two phases are separated, forming separated but interconnected plastic and silver networks. Thus, the conductivity in this region may be higher than that of pure build material. When a fusing agent is added, the silver particles become more embedded in the build material, creating a more mixed two-phase composition. Accordingly, the silver network may become less continuous, reducing its conductivity. As such, a conductive agent with the fusing agent therein increases resistance more than that of silver/build material composite without the fusing agent.

As described above, it may be desirable that embedded heat channels deform/bend without fracturing during deformation or reformation. In such an example, a heat channel that is 40% silver, 40% thermoplastic build material, and 20% fusing agent may provide a mixture with sufficient plasticity that does not result in fracturing of the resulting heat channels. Such a heat channel may exhibit a desired resistance which may allow reasonably low current, such as those of a 5-volt (V) battery, to raise a temperature of the adjacent build material past a glass transition temperature in under 3 minutes. Note that while particular reference is made to a metal-based conductive agent, other forms of conductive agents may be used including carbon-based materials and other metals and ceramics with high thermal conductivities.

The agent distribution system (212) may also deposit other agents. For example, as described below, the additive manufacturing system (100) may also form a rebound component to aid in returning the 3D object from a deformed shape to its original shape. That is, as described above, upon application of an applied stimulus and mechanical force, the 3D object may be deformed. In an example, based on a second application of the stimulus, this time without the mechanical force, a rebound component may be used to return the 3D object to its original shape.

In an example, such a rebound component may rely on a magnetic force to return the 3D object to its original shape. In this example, the agent distribution system (212) may deposit a magnetic agent. That is, along with the fusing agent and conductive agent, the agent distribution system (212) may selectively deposit magnetic agent(s) in two distinct regions, which regions have a magnetic attraction to one another to return the plastically deformable 3D object to its original shape.

As a specific example, oppositely polarized inks may be deposited separately to form the opposite poles of the magnetic rebound component. As another example, electromagnetic energy may be applied to align the polarity of the material on a per layer basis following agent deposition and prior to material hardening. In yet another example, magnetic particles such as ferrite nanoparticles, iron oxide nanoparticles, or cobalt nanoparticles in a ceramic material may be placed or printed in the regions of the 3D body where the rebound component is to be formed. In this example, after printing, a system may apply a magnetic field to increase the magnetization.

Note that without application of an applied stimulus, the 3D object is rigid and fixed, such that the magnetic attraction force of the magnetic rebound component does not return the plastically deformable 3D object to its original shape. However, upon application of the applied stimulus, when the build material is softened, the magnetic attraction force is sufficient to alter the form of the plastically deformable 3D object. Note that while FIG. 2 depicts a single box to represent the agent distribution system (212), the agent distribution system (212) may include distinct sub-assemblies, each to distribute a different of the aforementioned agents.

In some examples, an agent distribution device of the agent distribution system (212) includes at least one liquid ejection device to distribute an agent onto the layers of build material. A liquid ejection device may include at least one printhead (e.g., a thermal ejection based printhead, a piezoelectric ejection based printhead, etc.). In some examples, the agent distribution system (212) is coupled to a scanning carriage, and the scanning carriage moves along a scanning axis over the bed (208). In one example, printheads that are used in inkjet printing devices may be used in the agent distribution devices. In other examples, an agent distribution device of the agent distribution system (212) may include other types of liquid ejection devices that selectively eject small volumes of liquid.

FIG. 2 also clearly depicts an example fusing system (106).

Specifically, FIG. 2 depicts a fusing-agent based additive manufacturing system (FIG. 1, 100), where the fusing system (106) includes a heat lamp. However, in other examples, the fusing system (106) may include a laser such as in an SLM additive manufacturing system or an electron beam such as in an EBM additive manufacturing system. In these examples, the fusing system (106) may be coupled to a scanning carriage. In operation, the fusing system (106) directs fusing energy as the scanning carriage moves over the bed (208) along the scanning axis.

Each of the previously described physical elements may be operatively connected to a controller which controls the additive manufacturing. Specifically, in a fusing agent-based system, the controller may direct a build material distribution device (102) and any associated scanning carriages to move to add a layer of thermoplastic powder build material. Further, the controller may send instructions to direct a printhead of an agent distribution system (212) and any associated scanning carriages to move and selectively deposit the agent(s) onto the surface of a layer of the build material. The controller may also direct the fusing system (106) and any associated carriages to move and apply thermal energy to the bed (208).

The controller may include various hardware components, which may include a processor and memory. The processor may include the hardware architecture to retrieve executable code from the memory and execute the executable code. As specific examples, the controller as described herein may include computer readable storage medium, computer readable storage medium and a processor, an application specific integrated circuit (ASIC), a semiconductor-based microprocessor, a central processing unit (CPU), and a field-programmable gate array (FPGA), and/or other hardware device.

The memory may include a computer-readable storage medium, which computer-readable storage medium may contain, or store computer usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others. The executable code may, when executed by the controller cause the controller to implement at least the functionality of building a plastically deformable 3D object with embedded heat channels.

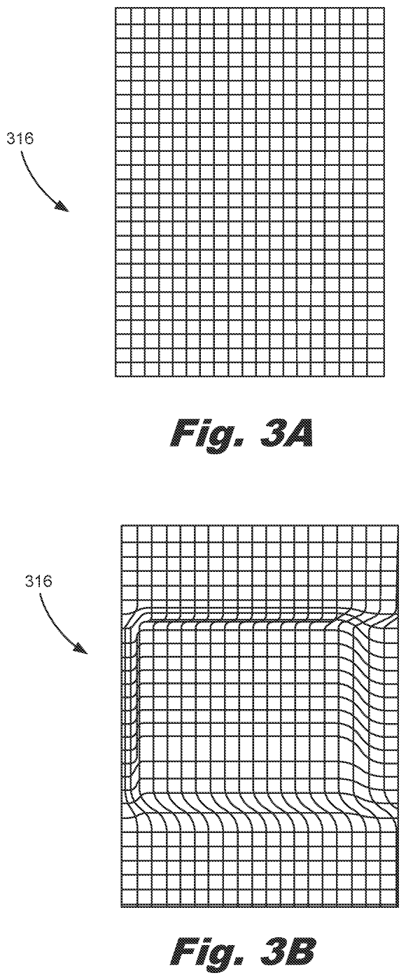

FIGS. 3A and 3B depict a plastically deformable 3D object (316) with heat channels, according to an example of the principles described herein. Specifically, FIG. 3A depicts the plastically deformable 3D object (316) prior to application of a stimulus to deform the 3D object (316) and FIG. 3B depicts the plastically deformable 3D object (316) following application of a stimulus. As depicted in FIG. 3A, the plastically deformable 3D object (316) may include a network of heat channels (represented as horizontal and vertical lines) dispersed throughout a matrix of build material which has been fused to form a solid body.

As described above, upon application of an applied energy such as heat or electricity in an amount to raise the temperature of the adjacent region past its glass transition temperature, the adjacent regions become pliable. Accordingly, under external force, the 3D object (316) may be deformed as depicted in FIG. 3B. When the applied stimulus is removed, the temperature of the adjacent regions begins to fall. As the temperature falls below the glass transition temperature, the body is no longer pliable but rigid and therefore maintains the deformed shape. As such, this 3D object (316) may be customized into a variety of shapes, for example to conform to any regular or irregular surface topography, based on the application of an electrical or thermal stimulus and an external mechanical force. In one particular example, the stimulus that is applied is a voltage or current over time. Specifically, voltage or current is applied to electrical leads which transfer the voltage or current through the heat channels to heat the local region of the 3D object.

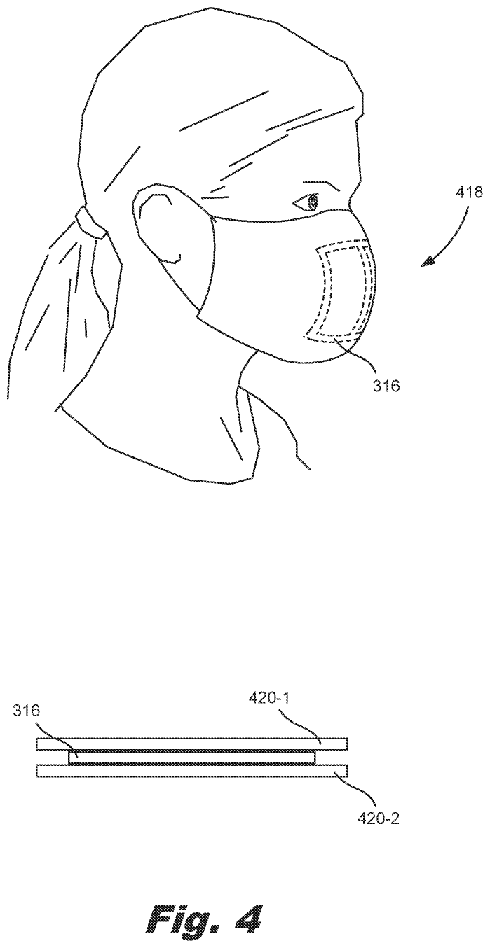

FIG. 4 depicts a plastically deformable 3D object (316) with heat channels, according to an example of the principles described herein. In the example depicted in FIG. 4, the 3D object (316) is a frame for a face mask (418) to be worn by a user. In general, such face masks (418) have one structure and may not conform to different facial characteristics. Accordingly, a face mask (418) that may be customized and contoured to an individual user may result in a better and more comfortable fit and may also increase the effectiveness of the face mask (418).

In this example, the 3D object (316) may be fabricated as a flat and patterned structure and may be customized as a user can adjust the shape to fit the unique contours of their face, for example by applying a thermal or electrical stimulus. In such an example, the 3D object (316) may be positioned between, or underneath, layers (420-1, 420-2) of face mask (418) material. Moreover, when not in use, the mask frame 3D object (316) may be flattened and stored.

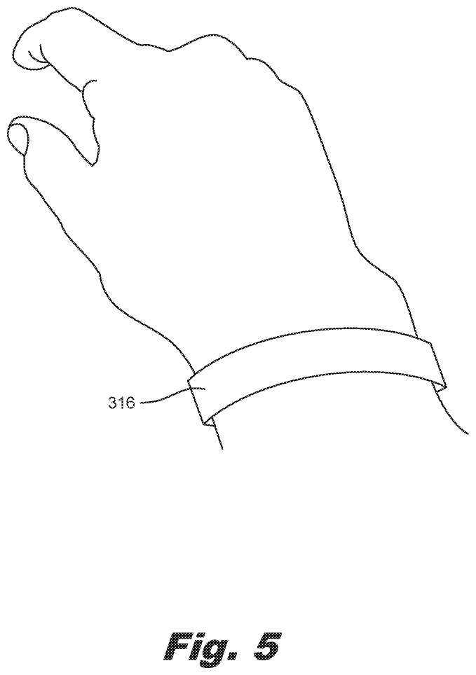

FIG. 5 depicts a plastically deformable 3D object (316) with heat channels, according to an example of the principles described herein. As described above, a plastically deformable 3D object (316) may be used in wearable technology. FIG. 5 depicts such an example where the 3D object (316) is a bracelet, which may have electronic components such as a display screen, processor, and/or memory.

In an example, a pinch force from human fingers may be around 20 Newtons (N). At this force, thermoplastic materials such as polyamide 12 may resist deformation and maintain its shape. For instance, a polyamide 12 plastic band with a 60-millimeter (mm) length, a 10-mm width, and a 3-mm thickness may require a 50 N bending force to deform. Accordingly, such a plastic band may not be able to deform from a human finger pinch force. Even in the face of a 50 N force, such a plastic band may return to its original form, and therefore is not plastically deformable. By comparison, upon application of a stimulus such that the temperature of the polyamide 12 raises to 60 degrees Celsius, the modulus of the polyamide 12 is reduced such that the plastic band is bendable under human finger force of about 16 N.

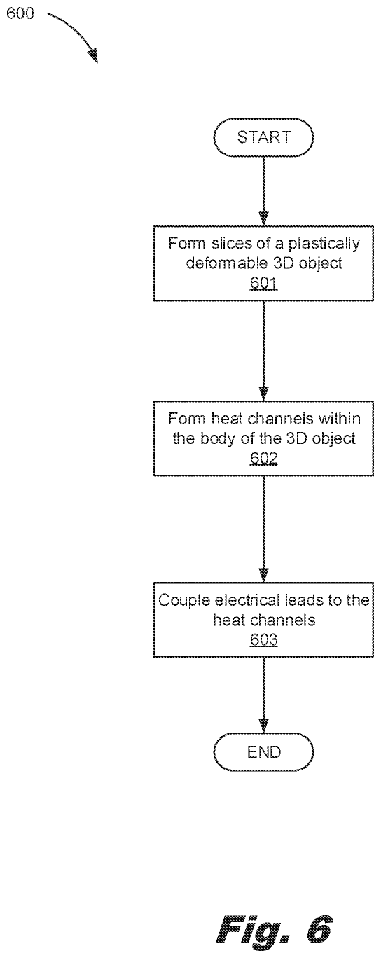

FIG. 6 is a flow chart of a method (600) for forming plastically deformable 3D objects (FIG. 3, 316) with heat channels, according to an example of the principles described herein. As described above, additive manufacturing involves the layer-wise deposition of build material and hardening/curing/sintering/fusing of certain portions of a layer to form a slice of a 3D object (FIG. 3, 316). Accordingly, in this example, the method (600) includes sequentially forming (block 601) slices of a plastically deformable 3D object (FIG. 3, 316). In some examples, this includes sequentially depositing layers of a powder thermoplastic build material and a fusing agent to form slices of a plastically deformable 3D object (FIG. 3, 316). This may include sequential activation, per slice, of a build material distribution device (FIG. 1,102) and an agent distribution system (FIG. 2, 212) and the scanning carriages to which they may be coupled so that each distribute a respective composition across the surface.

According to the method (600), heat channels are also formed (block 602) within a body of the plastically deformable 3D object (FIG. 3, 316). As described above, such heat channels deliver an applied stimulus to regions of the body of the plastically deformable 3D object (FIG. 3, 316) which are adjacent the heat channel such that these adjacent portions soften and are plastically deformable. Similar to the body of the plastically deformable 3D object (FIG. 3, 316), the heat channels may be formed in a layer-wise fashion. That is, forming a heat channel may include depositing powdered build material and depositing a conductive agent on portions of the slice of the plastically deformable 3D object (FIG. 3, 316) that correspond to the heat channels.

The method (600) also includes coupling (block 603) electrical leads to the heat channels to deliver the applied stimulus. That is, a stimulus source may be a battery, controller, or other electronic component that applies a thermal or electrical stimulus. As a particular example, the stimulus source may be a battery that applies a predetermined voltage, for example 5 V, to the electrical leads. The electrical leads may be metallic wires that are inserted, at least partially, into the body and that extend outside of the body. As such, a stimulus source may be electrically connected to the leads. A stimulus may then be delivered to the heat channels to soften the body of the plastically deformable 3D object (FIG. 3, 316) to allow for a plastically deformable 3D object (FIG. 3, 316).

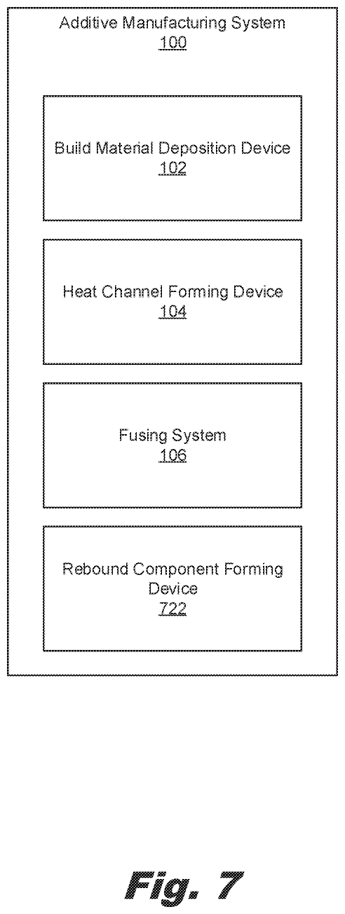

FIG. 7 is a block diagram of an additive manufacturing system (100) for forming plastically deformable 3D objects (FIG. 3, 316) with heat channels, according to an example of the principles described herein. As described above, the additive manufacturing system (100) may include a build material deposition device (102), a heat channel forming device (104), and a fusing system (106).

In this example the additive manufacturing system (100) includes additional components. Specifically, the additive manufacturing system (100) includes a rebound component forming device (722) to form a rebound component adjacent the heat channel. That is, as described above, when a stimulus such as heat or electricity is applied to the heat channels, they soften the adjacent regions of the plastically deformable 3D object (FIG. 3, 316), such that the plastically deformable 3D object (FIG. 3, 316) may deform. Once deformed and the stimulus is removed, the plastically deformable 3D object (FIG. 3, 316) remains in this deformed shape.

However, it may be desirable for the plastically deformable 3D object (FIG. 3, 316) to return to its original shape. For example, it may be easier to store the 3D object (FIG. 3, 316) in its original shape. As another example, it may be desirable to re-shape the plastically deformable 3D object (FIG. 3, 316). As a particular example, a face mask (FIG. 4, 418) may be deformed to match a particular user's facial contours. However, the user may find that the face mask (FIG. 4, 418) does not properly fit across a bridge of the nose. Accordingly, the user may desire to re-shape the face mask (FIG. 4, 418) to more accurately conform to the bridge of the nose. Before re-shaping the face mask (FIG. 4, 418), a user may first desire to return the face mask (FIG. 4, 418) to its original shape. The rebound component provides a simple and effective way of so doing.

For example, the rebound component may include a magnetic rebound component or an elastic rebound component. As described above, in one example the rebound component may be a magnetic rebound component that is placed in the 3D object (FIG. 3, 316) or printed during formation of the 3D object (FIG. 3, 316). In another example, the rebound component may be an elastic rebound component. For example, an elastic rebound component may be formed of an elastomer material. As such, when the stimulus is applied and no external force is applied to retain the 3D object (FIG. 3, 316) in its deformed state, the properties of the elastomer may return the 3D object (FIG. 3, 316) to its original form. In an example, the elastomer bridge may be separate from a bridge where a heat channel is formed.

To return the 3D object (FIG. 3, 316) to its original form, the stimulus may be applied. As described above, the applied stimulus may cause an adjacent region (which is now deformed), of the plastically deformable 3D object (FIG. 3, 316) to soften. In this case, the operation of the rebound component may act upon the softened material to return the plastically deformable 3D object (FIG. 3, 316) to its original shape. That is, when in the deformed shape and without an applied stimulus, the rebound component may not have enough force to be able to alter the shape of the plastically deformable 3D object (FIG. 3, 316). However, with the application of an applied stimulus which softens the material, the force of the rebound component may be enough to return the plastically deformable 3D object (FIG. 3, 316) to its original shape. That is, responsive to an application of the applied stimulus and without a mechanical force, the rebound component returns the adjacent regions of the body of the plastically deformable 3D object (FIG. 3, 316) from a deformed position to an undeformed position.

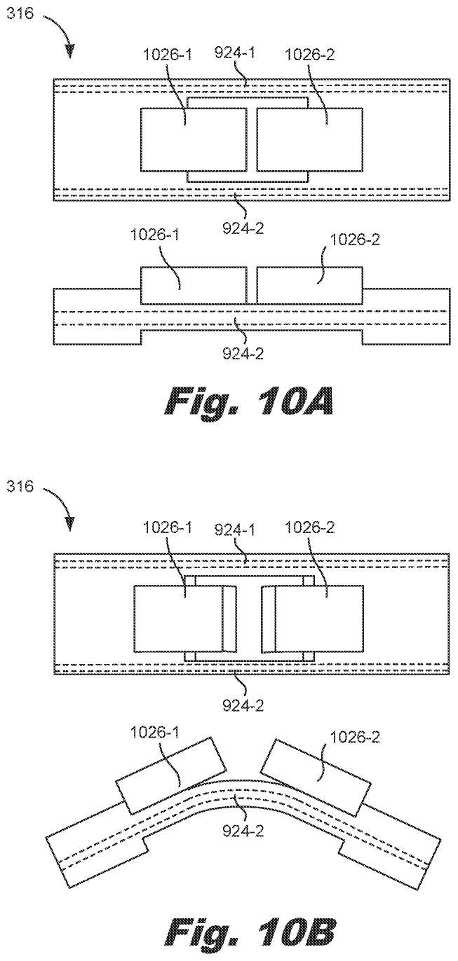

Returning to an earlier example, a polyamide 12 plastic band with a 60-mm length, a 10-mm width, and a 3-mm thickness may require a 50 N to change its shape, for example from a deformed shape to an original shape. By comparison, upon application of a stimulus such that the temperature of the polyamide 12 raises to 60 degrees Celsius, the modulus of the polyamide 12 is reduced such that the plastic band is bendable under a reduced force, which may be applied by the rebound component. FIGS. 10A and 10B provide an example of the deformation and rebound of a plastically deformable 3D object (FIG. 3, 316) which is facilitated by the rebound component.

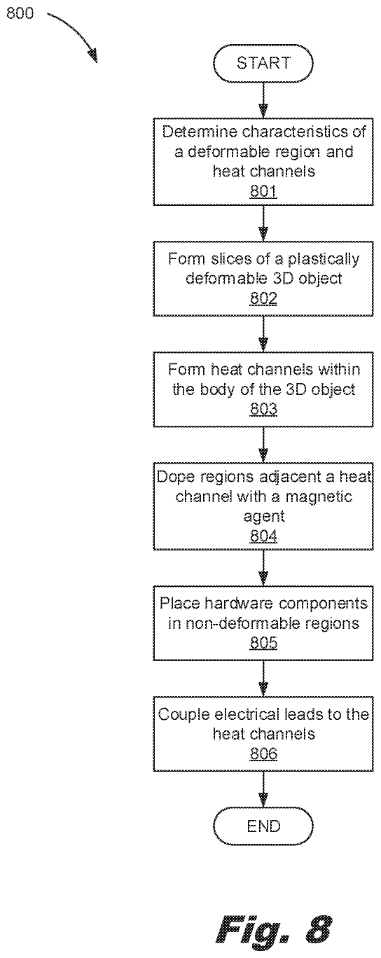

FIG. 8 is a flow chart of a method (800) for forming plastically deformable 3D objects (FIG. 3, 316) with heat channels, according to another example of the principles described herein. As an initial operation, characteristics of the deformable region and the heat channels may be determined (block 801). That is, the amount of deformation in a particular region may be defined by various characteristics including the physical dimensions of the adjacent region of the plastically deformable 3D object (FIG. 3, 316) and physical and electrical properties of the heat channels.

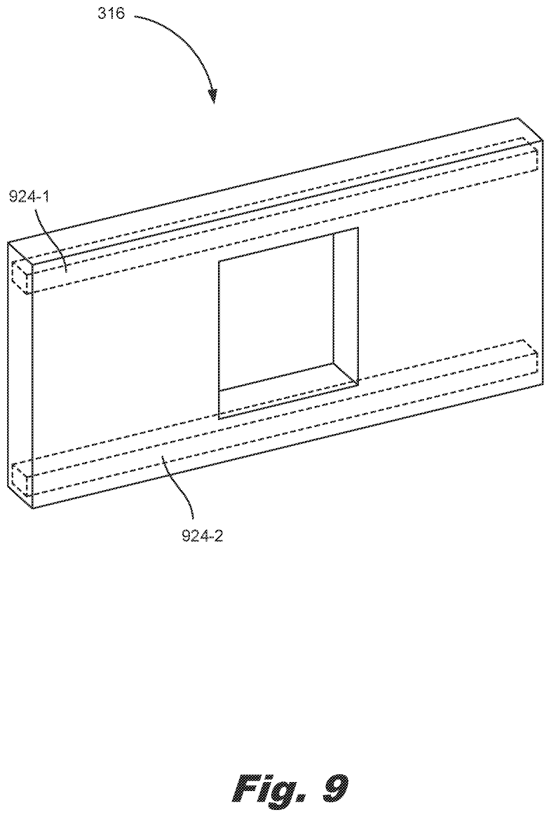

For example, a heat channel may be formed in a region of reduced cross-sectional area, such as a bridge depicted in FIG. 9. The reduced cross-sectional area may transfer heat more effectively. In a reduced cross-sectional area, the body material may reach the glass transition temperature more quickly due to there being less material to absorb the energy of the heat channels. In other words, the time to heat to the glass transition temperature may be affected by the size of the region to be heated.

In some examples, this deformable region may have a non-uniform cross-sectional area which produces a heat gradient across the deformable region when the stimulus is applied. Accordingly, even more customized and tailored heating, and by extension deformation, may be generated. For example, particular joints may be defined within the 3D object (FIG. 3, 316) along which deformation occurs, while other regions, that are thicker may be secondary bending points, or may be sufficiently thick that they do not bend, even when under the influence of an applied stimulus.

As another example, the properties, i.e., thickness, material, composition of the conductive agent, of the heat channel may similarly impact the conductivity of the heat channel. Accordingly, these properties may be varied to achieve a target deformation. For example, a user may select a desired deformation for a portion of the plastically deformable 3D object (FIG. 3, 316) and may select physical properties for the plastically deformable 3D object (FIG. 3, 316) and/or properties of the heat channels to effectuate the target deformation.

As described above, the method (800) includes forming (block 802) slices of the plastically deformable 3D object (FIG. 3, 316) and forming (block 803) heat channels within the body of the plastically deformable 3D object (FIG. 3. 316). These operations may be executed as described above in connection with FIG. 6.

A plastically deformable 3D object (FIG. 3, 316) may include a rebound component, which rebound component may be a magnetic rebound component formed by the additive manufacturing system (FIG. 1, 100). Accordingly, the method (800) may include doping (block 804) a region adjacent the heat channel with a magnetic agent to form the rebound component. For example, the agent distribution system (FIG. 2, 212) may deposit layers of the magnetic agent over regions of a layer of the build material that are to form the rebound component. In another example, formation of the rebound component may include placement of magnetic components with opposite polarity adjacent the heat channel. As described above, when in a deformed position and responsive to an applied stimulus, the rebound component returns the region adjacent the heat channel to an undeformed shape.

In an example, hardware components may be placed (block 805) in non-deformable regions of the plastically deformable 3D object (FIG. 3, 316). That is, in addition to the deformable regions, the 3D object (FIG. 3, 316) may also include non-deformable regions. In this example, hardware components may be placed in these non-deformable regions. Such hardware components may not be able to be effectively placed on deforming regions. As a particular example, a smart watch may include certain components such as a processor, memory, and/or a display device. In this example, these components may be placed within regions of the 3D object (FIG. 3, 316) that are void of heat channels and as such would not deform or heat up in the present of an applied stimulus. As such, the additive manufacturing system (FIG. 1, 100) of the present specification provides localized deformation being integrated with other components that may not be able to be placed on deformable objects.

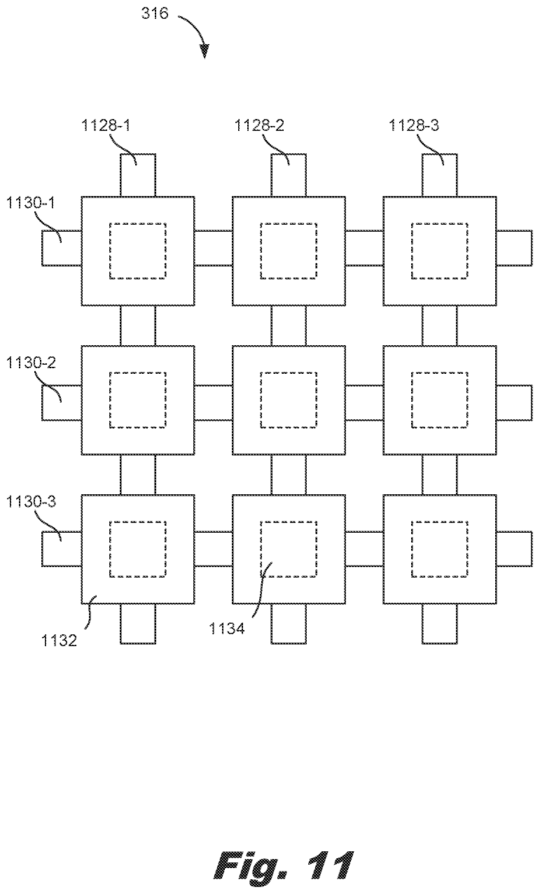

In one particular example, the hardware components are electrical components to route the applied stimulus throughout a network of heat channels. That is, it may be desirable to provide even more customized deformation by softening just a subset of the deformable regions so as to facilitate certain deformations, while preventing others. Accordingly, hardware components such as capacitors, transistors, resistors, etc. may be placed on the 3D object and may pass, stop, or re-direct an applied stimulus so as to facilitate a more directed and selectable 3D object (FIG. 3, 316) deformation. FIG. 11 provides an example of such hardware component placement. Electrical leads may then be coupled (block 806) to the heat channels. This may be performed as described above in connection with FIG. 6.

FIG. 9 depicts a plastically deformable 3D object (316) with heat channels (924-1, 942-2) in bridges, according to an example of the principles described herein. As described above, a heat channel (924-1) may pass through a region of the body of the plastically deformable 3D object (316) that has a reduced cross-sectional area relative to adjacent regions. That is, the heat channels (924-1, 924-2) may be formed in bridges of the body, a bridge referring to an area of reduced cross section between two adjacent areas of the body. In FIG. 9, the heat channels (924-1, 924-2) are depicted in dashed lines to represent their position internal to the body of the plastically deformable 3D object (FIG. 3, 316).

As noted above, structural properties define the heat transfer and efficacy of plastic deformation. Placing the heat channels (924) in a bridge of build material may simplify targeted deformation. Specifically, the bridges are less resistant to deformation such that less stimulus may be applied to effectuate any deformation. Moreover, the reduced area of the bridges results in less thermal resistance such that this region may achieve the glass transition temperature more quickly. Accordingly, 1) there may be less delay, following application of an applied stimulus, for the body to reach a deformable state, and 2) less energy may be applied to cause the softening of the build material.

In an example, the geometric properties of the bridge and the surrounding areas may be altered based on desired deformation characteristics (i.e., desired overall deformation, force to effectuate deformation, and time to result in glass transition). While FIG. 9 depicts bridges with particular geometric properties, the geometric properties may be adjusted in a variety of ways to effectuate any desired deformation characteristics.

FIGS. 10A and 10B depict the deformation of a plastically deformable 3D object (316) with heat channels (924-1, 924-2), according to an example of the principles described herein. FIGS. 10A and 10B also depict the rebound components (1026-1, 1026-2) which may be implemented. In the example depicted in FIGS. 10A and 10B, the rebound component (1026) includes differently charged magnetic devices separated by a gap. FIG. 10A depicts the plastically deformable 3D object (316) in a state where no stimulus is applied. However, following application of a stimulus and an external bending force, the body bends along the bridges as depicted in FIG. 10B. Once the electrical stimulus is removed, the plastically deformable 3D object (316) may harden and remain in this deformed state.

Following use, or as desired, the plastically deformable 3D object (316) may be returned to its original shape without any external user force. In this example, the attractive force of the magnetic rebound components (1026-1, 1026-2) provide the force to return the 3D object (316) to its original shape. Specifically, the stimulus may be applied such that the bridge regions of the plastically deformable 3D object (316) are softened. In this example, the attractive force of the magnets pulls these components together, returning the plastically deformable 3D object (316) to its original shape as depicted in FIG. 10A. In other words, the plastically deformable 3D object (316) is bendable once heated and is stable following removal of the applied stimulus and after the plastically deformable 3D object (316) temperature has fallen below the glass transition temperature. Once heated again, the plastically deformable 3D object (316) is flexible again and recovers to its original shape with the external force supplied by the rebound component (1026). This process may be repeatable.

FIG. 11 depicts a plastically deformable 3D object (316) with heat channels (FIG. 9, 924), according to an example of the principles described herein. Note that in this example, the plastically deformable 3D object (316) includes heat channel bridges (1130-1, 1130-2, 1130-3), which are bridges that contain heat channels (FIG. 9, 924). The plastically deformable 3D object (316) also includes other bridges (1128-1, 1128-2, 1128-3) that do not include heat channels (FIG. 9, 924). That is, these other channels (1128) may not receive any conductive agent doping. Such an arrangement facilitates targeted deformation as just the heat channel bridges (1130) are deformable.

In such a structure, the embedded heat channels (FIG. 9, 924) may be individually targeted by an electrical control system. For example, an electrical control system may pass voltages to individual heat channel bridges (1130) via electrical leads coupled to each heat channel bridge (1130). In an example, the electrical stimulus may be further routed through the network of heat channel bridges via activation of transistors, resistors, capacitors, etc. throughout the hardware component network.

FIG. 11 also depicts non-deformable regions (1132) where electrical components (1134) may be placed. The electrical components (1134) are depicted in dashed line to indicate their location internal to the non-deformable regions (1132). For simplicity a single non-deformable region (1132) and a single electrical component (1134) is indicated with a reference line.

As described above, by integrating electronic components (1134) such as transistors, capacitors, or batteries, into the plastically deformable 3D object (316), a selective heating system can be developed as shown in FIG. 11 where electrical signals can be routed through certain channels (FIG. 9, 924), providing control over which regions of the plastically deformable 3D object (316) are softened for deformation. Accordingly, by controlling heating locations, the resultant deformation modes of the plastically deformable 3D object (316) may be controlled.

Note that while FIG. 11 depicts a particular configuration of a plastically deformable 3D object (316) with particular non-deformable and deformable regions, any configuration and/or arrangement of such regions and the electrical components (1134) facilitate a plastically deformable 3D object (316) that is customizable with regards to its deformation. The customization is exhibited both during formation (i.e., selection of physical and electrical properties of the body and/or heat channels (FIG. 9, 924) and during use via targeted application and direction of a softening stimulus.

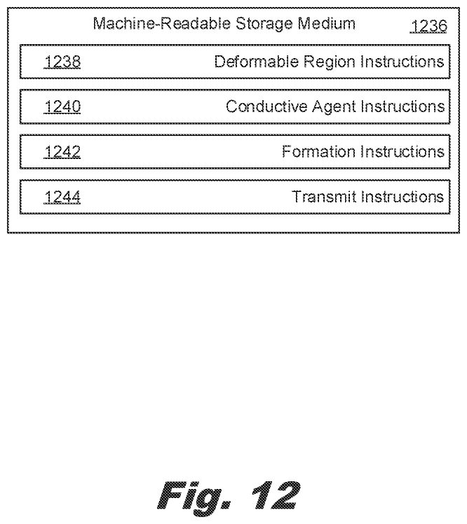

FIG. 12 depicts a non-transitory machine-readable storage medium (1236) for forming plastically deformable 3D objects (FIG. 3, 316) with heat channels (FIG. 9, 924), according to an example of the principles described herein. To achieve its desired functionality, a computing system includes various hardware components. Specifically, a computing system includes a processor and a machine-readable storage medium (1236). The machine-readable storage medium (1236) is communicatively coupled to the processor. The machine-readable storage medium (1236) includes a number of instructions (1238, 1240, 1242, 1244) for performing a designated function. The machine-readable storage medium (1236) causes the processor to execute the designated function of the instructions (1238, 1240, 1242, 1244). The machine-readable storage medium (1236) can store data, programs, instructions, or any other machine-readable data that can be utilized to operate the additive manufacturing system (FIG. 1, 100). Machine-readable storage medium (1236) can store computer readable instructions that the processor of the controller can process, or execute. The machine-readable storage medium (1236) can be an electronic, magnetic, optical, or other physical storage device that contains or stores executable instructions. Machine-readable storage medium (1236) may be, for example, Random Access Memory (RAM), an Electrically Erasable Programmable Read-Only Memory (EEPROM), a storage device, an optical disc, etc. The machine-readable storage medium (1236) may be a non-transitory machine-readable storage medium (1236).

Referring to FIG. 12, deformable region instructions (1238), when executed by the processor, cause the processor to determine deformable regions of a plastically deformable 3D object (FIG. 3, 316) to be formed. Conductive agent instructions (1240), when executed by the processor, may cause the processor to determine a conductive agent loading to generate heat channels (FIG. 9, 924) within the deformable region. Formation instructions (1242), when executed by the processor, may cause the processor to generate instructions to form the heat channels (FIG. 9, 924) in the deformable region. Transmit instructions (1244), when executed by the processor, may cause the processor to transmit the instructions to an additive manufacturing system (FIG. 1, 100), which forms the plastically deformable 3D object (FIG. 3, 316) and forms the heat channels (FIG. 9, 924) in the body of the plastically deformable 3D object (FIG. 3, 316).

Such systems and methods 1) provide re-shapeable devices; 2) facilitates control of the shape of the object to conform to a surface by stimulus such as heat or electricity; 3) facilitate shape-recovery of the 3D object from a deformed state to its original state; and 4) provide localized shape configuration. However, it is contemplated that the systems and methods disclosed herein may address other matters and deficiencies in a number of technical areas.

What is claimed is:

1. An additive manufacturing system, comprising:
a build material deposition device to form a plastically deformable three-dimensional (3D) object by depositing layers of a thermoplastic build material to form a body of the plastically deformable 3D object;
a heat channel forming device to form heat channels within the plastically deformable 3D object which heat channels, responsive to an applied stimulus, are to soften adjacent regions of the body; and
a fusing system to selectively harden layers of thermoplastic build material to form the plastically deformable 3D object.

2. The additive manufacturing system of claim 1, wherein the heat channel forming device comprises an agent distribution system to deposit a conductive agent onto regions of a layer of the thermoplastic build material that are to form the heat channels.

3. The additive manufacturing system of claim 2, wherein the conductive agent comprises a metallic ink and a fusing agent.

4. The additive manufacturing system of claim 1:
further comprising a rebound component forming device to form a rebound component adjacent the heat channel; and
wherein the rebound component is to, responsive to application of the applied stimulus without mechanical force, return the adjacent regions of the body from a deformed position to an undeformed position.

5. The additive manufacturing system of claim 4, wherein the rebound component comprises at least one of a magnetic rebound component and an elastic rebound component.

6. The additive manufacturing system of claim 5, wherein the rebound component forming device comprises an agent distribution system to deposit a magnetic agent.

7. The additive manufacturing system of claim 1, wherein a heat channel is formed in a region of the body that has a reduced cross-sectional area relative to adjacent regions.

8. A method, comprising:
forming slices of a plastically deformable three-dimensional (3D) object by sequentially depositing a powder thermoplastic build material to form a body of the plastically deformable 3D object;
forming heat channels within the body, wherein the heat channels are to deliver an applied stimulus to adjacent regions of the body to soften the adjacent regions such that the adjacent regions plastically deform; and
coupling electrical leads to the heat channels to deliver the applied stimulus.

9. The method of claim 8, wherein the heat channels are formed in bridges of the body, a bridge comprising an area of reduced cross section between two adjacent areas of the body.

10. The method of claim 8:
further comprising doping a region adjacent the heat channel with a magnetic agent to form a rebound component; and
wherein when in a deformed position and responsive to an applied stimulus, the rebound component returns the region adjacent the heat channel to an undeformed position.

11. The method of claim 8, further comprising placing hardware components in non-deformable regions of the 3D printed object.

12. The method of claim 11, wherein the hardware components are electrical components to route the applied stimulus throughout a network of heat channels.

13. A non-transitory machine-readable storage medium encoded with instructions executable by a processor, the machine-readable storage medium comprising instructions to:
determine deformable regions of a plastically deformable three-dimensional (3D) object to be formed;
determine a conductive agent loading to generate heat channels within the deformable regions;
generate instructions to form the heat channels in the deformable region; and
transmit the instructions to an additive manufacturing system to:
form the plastically deformable 3D object; and
form the heat channels in the body of the plastically deformable 3D object.

14. The non-transitory machine-readable storage medium of claim 13, further comprising instructions, executable by a processor, to determine characteristics of the deformable region and heat channels based on a target deformation.

15. The non-transitory machine-readable storage medium of claim 13, wherein the deformable region comprises a non-uniform cross-sectional area to impose a heat gradient across the deformable region.
